(19) United States
(12) Patent Application Publication
(10) Pub. No.: US 2008/0246886 A1
(43) Pub. Date: Oct. 9, 2008

(54) METHOD AND APPARATUS FOR RECEIVING DIGITAL CONTENTS THROUGH DATA BROADCASTING CHANNEL

(75) Inventors: Ju-ho HYUN, Suwon-si (KR); Hae-sik Jun, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/860,116

(22) Filed: Sep. 24, 2007

(30) Foreign Application Priority Data
Apr. 3, 2007 (KR) 10-2007-0032945

(51) Int. Cl. H04N 5/38; H04N 5/50; H04N 7/173

(52) U.S. Cl. 348/723; 348/731; 725/131; 725/38; 348/E05.093; 348/E05.097

(57) ABSTRACT

A method and apparatus for receiving digital contents through a data broadcasting channel are provided. The method includes analyzing information related to contents which is requested by a user while receiving broadcasting; and selectively receiving the contents through an idle tuner from among a plurality of tuners, according to the analysis result.

### CROSS-REFERENCE TO RELATED PATENT APPLICATION

This application claims the benefit of Korean Patent Application No. 10-2007-0032945, filed on Apr. 3, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to digital broadcasting, and more particularly, to receiving digital contents through a data broadcasting channel.

2. Description of the Related Art

Since digital broadcasting has begun being commercially used, interest in and the importance of digital broadcasting has increased, wherein the digital broadcasting sends data through a broadcasting stream. Current data broadcasting is mainly restricted to use of relatively small applications. However, it is believed that various digital contents will be supplied and used through digital broadcasting in the future. Therefore, in the near future, relatively large sized digital contents such as MP3s, moving picture files, and software will be provided through digital broadcasting, and various business models, such as product sales through digital broadcasting, will be newly generated. For example, while a music program is on the air from a music broadcasting channel, new songs by singers appearing in the program may be sold or distributed in MP3 form. In addition, in a movie channel, when a movie introducing broadcast is on the air, the introduced movie contents may be sold. Since broadcasting and a purchasing process progress at the same time as a home shopping program, a customer's sudden interest will be induced so that large added value will be created.

In order to embody such a business model, massive amounts of digital contents should be transmitted through a data broadcasting channel. However, there is a technical problem to receive massive amounts of digital contents through a data broadcasting channel.

FIG. 1 is a flowchart of a related art method of receiving contents through a data broadcasting channel.

In operation 100, a user designates contents and requests to download the contents.

In operation 110, a data broadcasting receiving device such as digital TV or a set top box analyses a Program Mapping Table (PMT) to obtain a packet ID (PID) of the requested contents and receives contents by using the obtained PID.

In operation 120, the user changes a channel while receiving the contents.

In operation 130, a tuner terminates receiving the contents to change a broadcasting channel.

That is, when a physical channel is changed while receiving the contents through a data broadcasting channel, a tuner receives a different transport stream (TS) and thus transmission of the receiving contents is terminated. Therefore, the user cannot change a channel while receiving massive amounts of contents. If the user changes a channel, the contents need to be completely downloaded again.

Furthermore, even if there are not massive amounts of contents, in the case of contents such as user authentication information or information transmitted/received for payment that should not be terminated while receiving, the user cannot use a service of another channel before transmission of the contents is completed.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and apparatus for changing a channel while receiving contents through a broadcasting channel.

According to an aspect of the present invention, there is provided a method of receiving data in an apparatus for receiving data broadcasting, the method comprising: analyzing information related to contents which are requested by a user while receiving broadcasting; and selectively receiving the contents through an idle tuner from among a plurality of tuners, in response to the analysis result.

The analyzing may comprise determining if an indicator which indicates that the requested contents should be received through an idle tuner is included in the contents related information.

The contents related information may comprise at least one of a Program Mapping Table (PMT), an Event Information Table (EIT), and a Download Information Indicator (DII).

The receiving may comprise: searching whether the idle tuner among the tuners exists, in response to the contents being determined to be received by using the idle tuner; receiving the contents by using the idle tuner when it is determined that the idle tuner exists, or completing service provided by at least one tuner from among the used tuners according to a user's input when it is determined that the idle tuner does not exist; and receiving the contents by using the tuner which completes the service.

According to another aspect of the present invention, there is provided a recording medium having embodied thereon a program for executing the method of receiving data.

According to another aspect of the present invention, there is provided an apparatus for receiving data broadcasting including a plurality of tuners, the apparatus comprising: an analyzing unit which analyzes information related to contents that are requested by a user while receiving broadcasting; and a receiving unit which selectively receives the contents through an idle tuner from among the plurality of tuners, in response to the analysis result.

According to another aspect of the present invention, there is provided a method of transmitting data broadcasting, the method comprising: generating an indicator which indicates that contents should be received by using an idle tuner in a reception side; inserting the generated indicator into corresponding contents related information; and transmitting the information to the reception side.

The contents related information may comprise at least one of a Program Mapping Table (PMT), an Event Information Table (EIT), and a Download Information Indicator (DII).

According to another aspect of the present invention, there is provided a method of transmitting data broadcasting.

According to another aspect of the present invention, there is provided an apparatus for transmitting data broadcasting, the apparatus comprising: an indicator generating unit which generates an indicator indicating that contents should be received by using an idle tuner in a reception side; an information processing unit which inserts the generated indicator into corresponding contents related information; and a transmitting unit which transmits the information to the reception side.

### BRIEF DESCRIPTION OF THE DRAWINGS

The above and other aspects of the present invention will become more apparent by describing in detail exemplary embodiments thereof with reference to the attached drawings in which:

FIG. 1 is a flowchart of a related art method of receiving contents through a data broadcasting channel;

FIG. 2 is a flowchart of a method of receiving contents according to an exemplary embodiment of the present invention;

FIG. 3 is a flowchart of a process of analyzing contents related information according to an exemplary embodiment of the present invention;

FIG. 4 is a flowchart of an exemplary procedure when an indicator is included in contents;

FIG. 5 shows an example of a message output to a user when it is determined that an indicator is included in contents;

FIG. 6 is a block diagram of an apparatus for receiving data broadcasting according to an exemplary embodiment of the present invention;

FIG. 7 is a flowchart of a method of transmitting data broadcasting according to an exemplary embodiment of the present invention; and

FIG. 8 is a block diagram of an apparatus for transmitting data broadcasting according to an exemplary embodiment of the present invention.

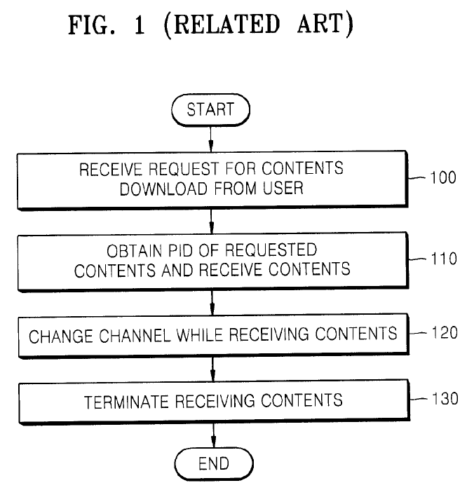

### DETAILED DESCRIPTION OF THE INVENTION

Hereinafter, the present invention will be described more fully with reference to the accompanying drawings, in which exemplary embodiments of the invention are shown.

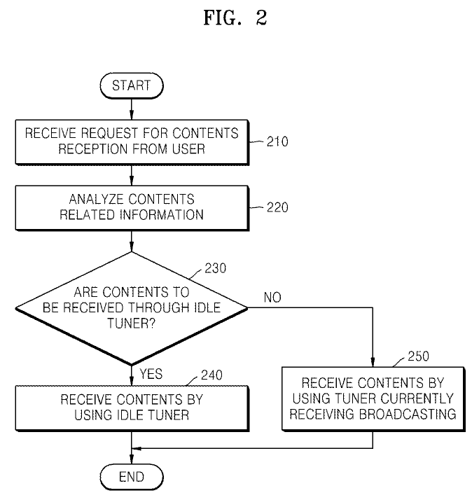

FIG. 2 is a flowchart of a method of receiving contents according to an exemplary embodiment of the present invention.

Recently, two or more tuners are generally included for a Picture In Picture (PIP) or Personal Video Recorder (PVR) function in digital TVs or set top boxes. However, when PIP or PVR is not used, an idle tuner exists while receiving broadcasting. Therefore, in an exemplary embodiment of the present invention, contents are received by using the idle tuner.

In operation 210, a user inputs a command for downloading contents into an apparatus for receiving data broadcasting through a user interface while watching broadcasting.

In operations 220 and 230, the apparatus for receiving data broadcasting analyzes contents related information that is requested by the user and determines the type of contents. In other words, whether the contents requested by the user are the contents that should be received by an idle tuner is determined. As mentioned above, examples of the contents that should be received by using an idle tuner include important contents, such as massive amounts of contents and authentication information, and the type of contents is determined by a broadcasting station from where the contents are provided.

A contents provider selects the contents that should be received through the idle tuner according to the type of contents and then inserts an indicator indicating that the contents corresponding to contents related information should be received through the idle tuner. The information may include various meta data related to contents, for example, a Program Mapping Table (PMT), an Event Information Table (EIT), and a Download Information Indicator (DII). Such information is used in existing data broadcasting. The PMT, EIT, and DII are described in detail in ISO/IEC 13818-1, ETSI EN 300 468, and ISO/IEC 13818-6 standards, respectively and thus a detailed description thereof is omitted here.

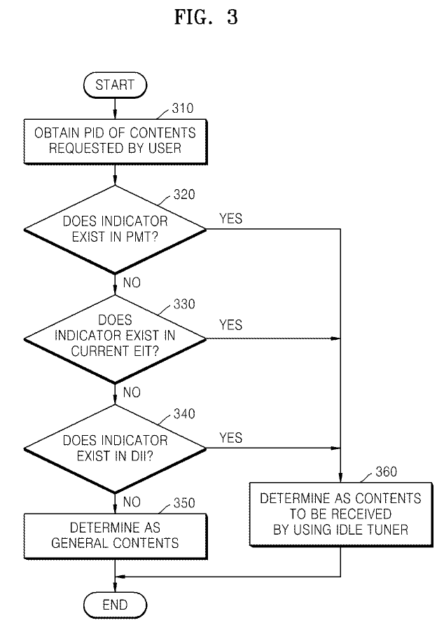

Determining the type of contents in operations 220 and 230 may be performed by examining whether the indicator is included in contents related information. A more detailed description of the exemplary embodiment will be illustrated with reference to FIG. 3.

If the type of contents requested by the user should be received through the idle tuner, the corresponding contents are received by using the idle tuner of the apparatus for receiving data broadcasting in operation 240. If the type of contents requested by the user should not be received through the idle tuner, the corresponding contents are received by using a tuner currently receiving broadcasting in operation 250.

FIG. 3 is a flowchart of a process of analyzing contents related information according to an exemplary embodiment of the present invention.

As mentioned above, the indicator indicating whether the type of contents should be received through the idle tuner may be included in the PMT, EIT, and DII, and more preferably, may be included in any one piece of information. However, in the current exemplary embodiment, it is assumed that the apparatus for receiving data broadcasting does not identify where the indicator is included among the information. All information is examined to determine the type of contents.

In operation 310, the PMT is analyzed to obtain a packet ID (PID) that corresponds to the contents requested by a user.

In operation 320, whether the indicator exists in contents related information requested by the user from the PMT is searched. If the indicator exists, the contents requested by the user are determined as the contents that should be received by using the idle tuner in operation 350. If the indicator does not exist, operation 330 is performed.

In operation 330, the current EIT is searched for the indicator. More specifically, a component tag which is mapping information of the PID is used in the EIT, instead of the PID. In the PMT, a relationship between the PID and the component tag can be determined. Therefore, if the indicator is found in the EIT, the PID corresponding to the corresponding component is detected in the PMT. Then, only when the detected PID corresponds to the PID obtained in operation 310, the contents requested by the user are determined as the contents that should be received through the idle tuner (proceed to operation 350). In other words, when the indicator is found in the EIT but the PID corresponding to the corresponding component tag does not correspond to the PID requested by the user, operation 340 is performed.

In operation 340, the DII is searched for the indicator. When the indicator exists, operation 360 is performed. When the indicator does not exist, operation 350 is performed and the contents requested by the user are determined as general contents.

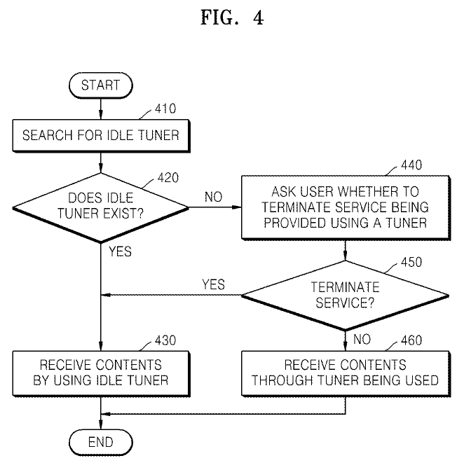

FIG. 4 is a flowchart of an exemplary procedure when an indicator is included in contents. That is, the procedure is that performed when the contents requested by the user are determined to be received by using the idle tuner.

In operations 410 and 420, the idle tuner is searched to determine whether an idle tuner exists in the apparatus for receiving data broadcasting. If an idle tuner exists, the contents requested by the user are received by using the idle tuner. The tuner currently receiving data broadcasting and the tuner receiving the contents requested by the user are different, and therefore the user can change a channel while receiving the contents so as to use a service provided through another channel.

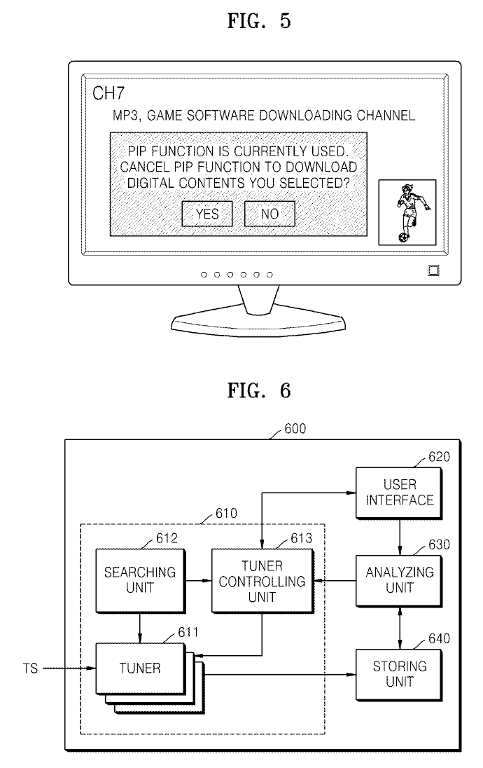

In operations 440 and 450, if the idle tuner does not exist, the apparatus for receiving data broadcasting outputs a message enquiring of the user whether to terminate a service currently being provided through one of the occupied tuners through a user interface. An example of the output message is illustrated in FIG. 5.

If the user desires to terminate a service being provided by one tuner from among occupied tuners to make it idle, operation 430 is performed and if not, operation 460 is performed to receive the contents by using the tuner currently receiving broadcasting. In operation 460, if the user changes a channel before the contents are completely received, reception of the contents would be terminated as in the related art.

FIG. 5 shows an example of a message output to a user if it is determined that an indicator is included in contents.

In the current exemplary embodiment, the user requests to download the contents including the indicator while using services of two channels by using a PIP function of a digital TV and it is assumed that the apparatus for receiving digital broadcasting is equipped with two tuners. Since the idle tuner does not exist in the apparatus for receiving digital broadcasting, the tuner providing PIP service is formed according to the idle tuner and then a message illustrated as in FIG. 5 is output so as to download the contents requested by the user through the idle tuner.

If the user selects “yes” on the illustrated screen, a football program broadcasted through a PIP service is completed and the tuner used in the PIP service is then used to receive the contents requested by the user. If the user selects “no”, the PIP service is continuously provided and the contents requested by the user is received through the tuner currently receiving broadcasting. However, if the user changes a channel, reception of the contents will be terminated.

FIG. 6 is a block diagram of an apparatus for receiving data broadcasting according to an exemplary embodiment of the present invention.

Referring to FIG. 6, the apparatus for receiving data broadcasting 600 includes a receiving unit 610, a user interface 620, an analyzing unit 630, and a storing unit 640.

The analyzing unit 630 analyzes contents related information that is requested additionally through the user interface 620 while the user watching broadcasting and determines whether the corresponding contents should be received through the idle tuner. As described above, analyzing contents related information is determining whether the indicator is included in the contents related information such as PMT, EIT, and DII.

The receiving unit 610 receives the contents requested by the user through one of a plurality of tuners 611 according to the determination result. The receiving unit 610 includes the plurality of tuners 611, a searching unit 612, and a tuner controlling unit 613. When the contents requested by the user are the contents that should be received through the idle tuner, the searching unit 612 searches for the idle tuner from among the plurality of tuners 611.

When the idle tuner exists according to the searching result, the tuner controlling unit 613 designates the searched idle tuner as the tuner to receive the contents. When the idle tuner does not exist, a message as illustrated in FIG. 5 is output to the user through the user interface 620. When the user selects “yes” in an example of FIG. 5, the tuner controlling unit 613 completes the service provided by at least one of the currently used tuners to form the idle tuner and then designates the tuner as the tuner to receive the contents requested by the user.

The storing unit 640 stores various data received through the receiving unit 610 such as a broadcasting stream, the contents requested by the user, and the PMT.

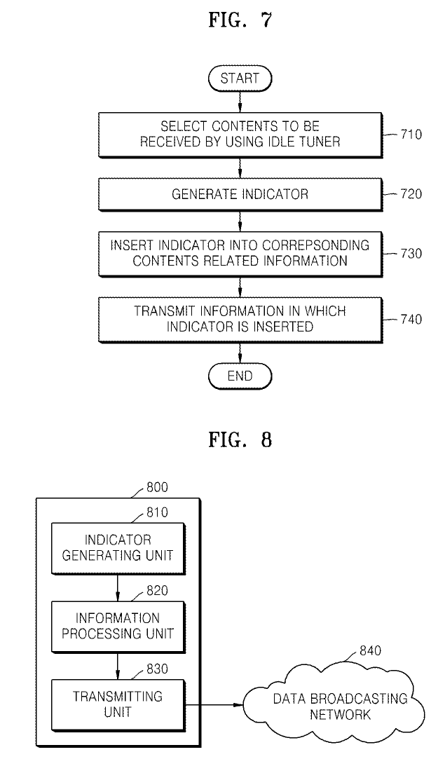

FIG. 7 is a flowchart of a method of transmitting data broadcasting according to an exemplary embodiment of the present invention.

In operation 710, the contents to be received by using the idle tuner is selected from among various contents provided through a data broadcasting channel.

In operation 720, an indicator indicating the contents to be received by using the idle tuner is generated.

In operation 730, the generated indicator is inserted into contents related information. Here, the information may be the PMT, EIT, and DII as mentioned above.

In operation 740, the indicator transmits the inserted information through a data broadcasting channel.

FIG. 8 is a block diagram of an apparatus for transmitting data broadcasting according to an exemplary embodiment of the present.

Referring to FIG. 8, the apparatus for transmitting data broadcasting 800 includes an indicator generating unit 810, an information processing unit 820, and a transmitting unit 830.

The indicator generating unit 810 generates the indicator indicating the contents to be received by using the idle tuner and the information processing unit 820 inserts the generated indicator into information such as the PMT, EIT, and DII.

The transmitting unit 830 transmits information, in which the indicator is inserted, through a data broadcasting network 840.

The exemplary embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

According to an exemplary embodiment of the present invention, while receiving contents requested by a user, the user can change a broadcasting channel and use a service provided by another channel in the apparatus for receiving data broadcasting. In addition, the contents are received by using the idle tuner and thus desired contents can be quickly received.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of receiving data in an apparatus for receiving data broadcasting, the method comprising:
analyzing information related to contents which is requested by a user while receiving broadcasting; and
selectively receiving the contents through an idle tuner from among a plurality of tuners, according to the analysis result.

2. The method of claim 1, wherein the analyzing comprises determining if an indicator which indicates that the requested contents should be received through an idle tuner is included in the contents related information.

3. The method of claim 2, wherein the contents related information comprises at least one of a Program Mapping Table (PMT), an Event Information Table (EIT), and a Download Information Indicator (DII).

4. The method of claim 3, wherein the determining comprises searching the at least one of a PMT, EIT and DII for the indicator.

5. The method of claim 1, wherein the receiving comprises:
searching whether the idle tuner among the tuners exists, when the contents are determined to be received by using the idle tuner;
receiving the contents by using the idle tuner if it is determined that the idle tuner exists.

6. A method of claim 5, further comprising:
completing service provided by at least one tuner from among a plurality used tuners according to a user's input if it is determined that the idle tuner does not exist; and
receiving the contents by using the at least one tuner from among the plurality of used tuners.

7. A recording medium having embodied thereon a program for executing a method of receiving data in an apparatus for receiving data broadcasting, the method comprising:
analyzing information related to contents which is requested by a user while receiving broadcasting; and
selectively receiving the contents through an idle tuner from among a plurality of tuners, according to the analysis result.

8. An apparatus for receiving data broadcasting including a plurality of tuners, the apparatus comprising:
an analyzing unit which analyzes information related to contents that are requested by a user while receiving broadcasting; and
a receiving unit which selectively receives the contents through an idle tuner from among the plurality of tuners, according to the analysis result.

9. The apparatus of claim 8, wherein the analyzing unit determines if an indicator which indicates that the requested contents should be received through an idle tuner is included in the contents related information.

10. The apparatus of claim 9, wherein the contents related information comprises at least one of a Program Mapping Table (PMT), an Event Information Table (EIT), and a Download Information Indicator (DII).

11. The apparatus of claim 10, wherein the analyzing unit determines if the indicator is included by searching the at least one of a PMT, EIT and DII for the indicator.

12. The apparatus of claim 8, wherein the receiving unit comprises:
a searching unit which searches whether the idle tuner among the tuners exists, in response to the contents being determined to be received by using the idle tuner;
a tuner controlling unit which designates the found idle tuner as the tuner to receive the contents in response to the determination that the idle tuner exists.

13. A method of claim 12, wherein the tuner controlling unit designates at least one tuner from among a plurality of used tuners to receive the contents according to a user's input in response to the idle tuner not existing; and
receiving the contents by using the at least one tuner from among the plurality of used tuners.

14. A method of transmitting data broadcasting, the method comprising:
generating an indicator which indicates that contents should be received by using an idle tuner in a reception side;
inserting the generated indicator into corresponding contents related information; and
transmitting the information to the reception side.

15. The method of claim 14, wherein the contents related information comprises at least one of a Program Mapping Table (PMT), an Event Information Table (EIT), and a Download Information Indicator (DII).

16. A recording medium having embodied thereon a program for executing a method of transmitting data broadcasting, the method comprising:
generating an indicator which indicates that contents should be received by using an idle tuner in a reception side;
inserting the generated indicator into corresponding contents related information; and
transmitting the information to the reception side.

17. An apparatus for transmitting data broadcasting comprising:
an indicator generating unit which generates an indicator which indicates that contents should be received by using an idle tuner in a reception side;
an information processing unit which inserts the generated indicator into corresponding contents related information; and
a transmitting unit which transmits the information to the reception side.

18. The apparatus of claim 17, wherein the contents related information comprises at least one of a Program Mapping Table (PMT), an Event Information Table (EIT), and a Download Information Indicator (DII).
